(19) United States
(12) Patent Application Publication
(10) Pub. No.: US 2008/0160937 A1
(43) Pub. Date: Jul. 3, 2008

(54) WIRELESS SENSING SYSTEMS AND CONTROL METHODOLOGIES

(75) Inventors: Douglas M. Baker, Ypsilanti, MI (US); Timothy J. Wilson, Ypsilanti, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: TECAT ENGINEERING, INC., ANN ARBOR, MI (US)

(21) Appl. No.: 11/828,038

(22) Filed: Jul. 25, 2007

Related U.S. Application Data
(60) Provisional application No. 60/820,264, filed on Jul. 25, 2006.

(51) Int. Cl. H04B 1/04

(52) U.S. Cl. 455/127.5

(57) ABSTRACT

A method of operating a wireless sensing system includes activating a sensor to generate an output. A transmitter is activated, and is in electrical communication with the sensor to receive the sensor output signal. The sensor output signal is transmitted by the transmitter to a receiver. The transmitter is then de-activated after the transmitting step.

### CROSS REFERENCE TO RELATED APPLICATION

This application claims the benefit of application Ser. No. 60/820,264 filed Jul. 25, 2006.

### BACKGROUND OF THE INVENTION

1. Field of the Invention

The subject invention relates generally to a method of operating a wireless sensing system.

2. Description of the Prior Art

A variety of sensing systems are used in vehicular applications to detect, monitor, and determine current vehicle status and performance information. The information may be used day-to-day in the control of onboard vehicle systems and components, for vehicle maintenance, service, or diagnostic reasons, or for research, testing, evaluating, and designing purposes. One known sensing system that is commonly used to measure torque is referred to as a torque telemetry system. Telemetry is the wireless transmission of measured data. The information obtained from the torque telemetry system typically pertains to drivetrain components, such as crankshafts and driveshafts, but may also refer to that from connecting rods, wheels, motors, gearboxes, propellers, and the like.

The torque telemetry information is wirelessly received and used by onboard controllers to improve vehicle performance. For example, the torque telemetry information may be used in conjunction with a torque-based control strategy to adjust fuel and air supply to an engine, operating temperatures of an engine, transmission gearing, and other vehicle drivetrain and non-drivetrain related parameters. The information gathered may also be used in normal vehicle operation or in a testing environment for thermodynamic system control and monitoring. In the testing environment, the stated information is often used in the design and evaluation of a vehicle drivetrain.

In drivetrain applications, the torque telemetry system typically includes a transmitter with a power supply, which is attached to a driveshaft. A receiver is in wireless communication with the transmitter and receives real time data from the transmitter that is downloaded in a useful format to an onboard controller, an offboard controller, or a data acquisition system.

To reduce the costs associated with the wiring of the torque telemetry system, the transmitter power supply has traditionally been in the form of a lightweight portable power source, such as a battery. A significant limiting factor of traditional torque telemetry systems is the short life span of the transmitter power supply. The transmitter power supply that is typically used is a nine (9)-volt battery. The life span of the 9-volt battery, using traditional control methodologies, is typically less than twelve (12) hours.

There is a desire to increase battery life within a torque telemetry system for reduced costs and weight associated therewith. As such, there exists a need for an improved torque telemetry system and technique for control thereof that increases the life span of a transmitter power source by reducing the electrical current demand of the system.

### SUMMARY OF THE INVENTION AND ADVANTAGES

A method of operating a wireless sensing system includes activating a sensor to generate an output. A transmitter is activated, and is in communication with the sensor to receive the sensor output signal. The sensor output signal is transmitted by the transmitter to a receiver. The transmitter is then de-activated after the transmitting step.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic view of a first exemplary torque telemetry system;

FIG. 2 is a schematic view of a second exemplary torque telemetry system;

FIG. 3 is a schematic view of a third exemplary torque telemetry system;

FIG. 4A is a flow-chart of a method of operating a wireless sensing system according to a first embodiment of the present invention;

FIG. 4B is a flow-chart of a continuation of the method of FIG. 4A; and

FIG. 5 is a flow-chart of a method of operating a wireless sensing system according to a second embodiment of the present invention.

### DETAILED DESCRIPTION OF THE INVENTION

Although the present invention is described primarily with respect to torque telemetry sensors and systems, the present invention may be applied to other wireless sensors, battery operated sensors, and associated systems. For example, the sensor may be a thermocouple or RTD used for measuring temperature or an accelerometer used for measuring accelerations.

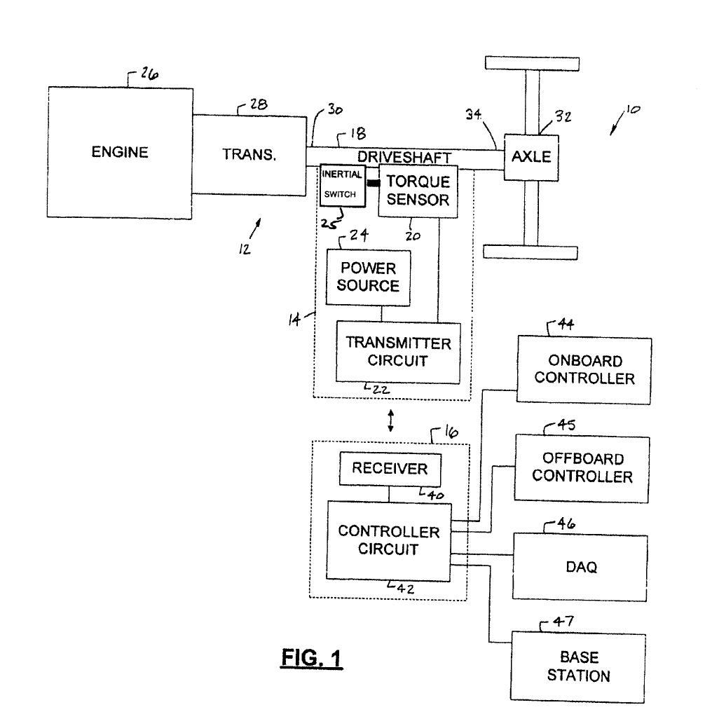

FIG. 1 provides a first exemplary torque telemetry system 10 that is coupled to a drivetrain 12. The torque telemetry system 10 includes a transmitter unit 14 and a receiver unit 16. The transmitter unit 14 is attached to a driveshaft 18 of the drivetrain 12. The receiver unit 16 is remotely located from the transmitter unit 14. The receiver unit 16 may be located anywhere within a vehicle, a test stand, a testing lab or environment, or in other locations known in the art.

The transmitter unit 14 includes a torque sensor 20, a transmitter circuit 22, a power source 24, and an inertial switch 25. The torque sensor 20 detects torque applied to the driveshaft 18 by the engine 26 and the transmission 28, which are coupled to a first end 30 of the driveshaft 18, relative to an axle/wheel assembly 32. The axle/wheel assembly 32 is coupled on a second end 34 of the driveshaft 18. The torque sensor 20 generates a torque signal that is received by the transmitter circuit 22. Upon reception of the torque signal, the transmitter circuit 22 may signal condition the torque signal and then transmits the conditioned signal to the receiver unit 16. The power source 24 is coupled to the transmitter circuit 22 and supplies power thereto.

The receiver unit 16 includes a signal receiver 40 and a control circuit 42. The receiver 40 receives the conditioned torque signal, which may be converted and/or processed by the control circuit 42 and provided to an onboard controller 44, a remote/offboard controller 45, or to some other testing, evaluating, or monitoring system, such as a data acquisition system (DAQ) 46, or base station 47.

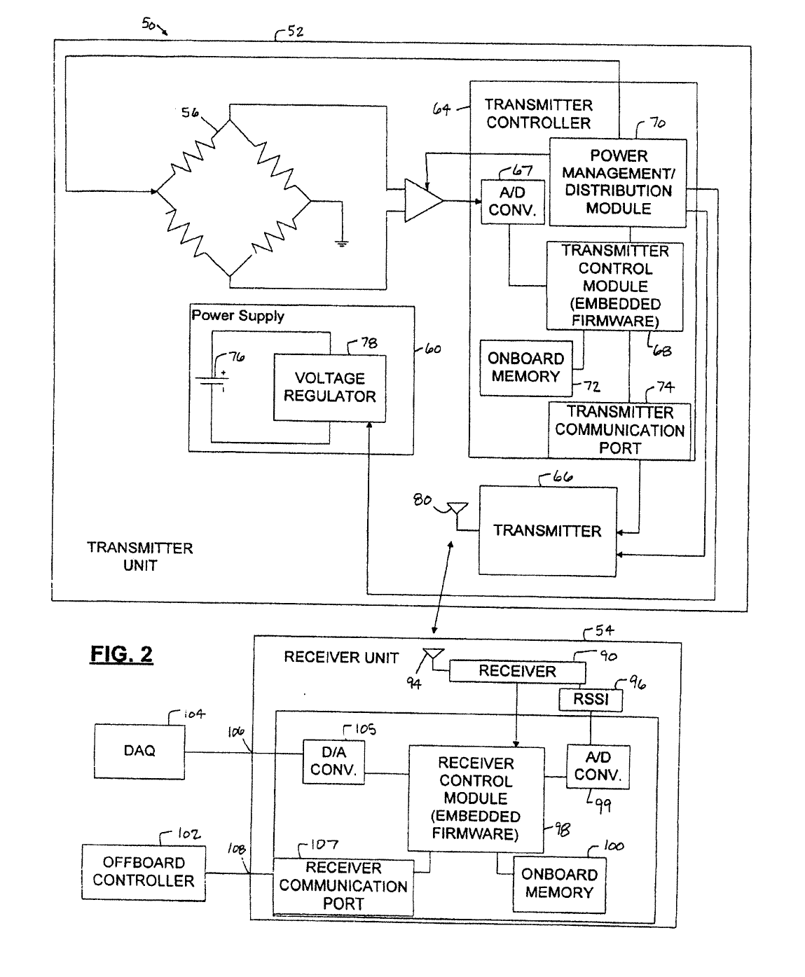

FIG. 2 provides a second exemplary torque telemetry system 50. The torque telemetry system 50 also includes a transmitter unit 52 and a receiver unit 54. The transmitter unit 50 includes a torque sensor 56, a transmitter circuit 58, and a power supply 60. The torque sensor 56 is shown in the form of a full wheatstone bridge, which performs as a strain gauge or as a device used to measure resistance change on a strain gauge. Although a full wheatstone bridge is shown, other torque sensor or torque sensor configurations known in the art may be utilized. The torque sensor 56 is used to measure torque applied to a rotating device, such as the above-mentioned driveshaft 18.

The transmitter unit 50 may be configured differently depending upon the modes of data transmission and communication desired and the application. The transmitter unit 50 is capable of acquiring and storing data for later transmission, of transmitting data in real time, and of processing and transmitting resultant data.

The transmitter circuit 58 includes an amplifier 62, a transmitter controller 64, and a transmitter 66, which may be radio frequency (RF) based. The amplifier 62 is coupled to the torque sensor 56 and is used to amplify the torque signal received therefrom. The transmitter controller 64 includes a 10-bit A/D converter 67, a transmitter control module 68, and a power management/distribution module 70. The A/D converter 67 converts the analog signal received from the torque sensor 56 to a digital signal. Of course, A/D converters of various size or bit number may be used. The control module 68 may signal condition the amplified signal prior to providing such to the transmitter 66. In signal conditioning, the control module 68 may average data and reject noise points. The control module 68 may also generate error correction codes, such as parity (the correct number of ones), checksum (sum of bits received or transmitted), cycle redundancy code (CRC), and other codes for transmission to the receiver unit 54. The RF transmitter 66 communicates the detected and conditioned digital torque signal to the receiver unit 54. The power module 70 provides power received from the power supply 60 to the torque sensor 56, the amplifier 62, and the transmitter 66.

The control module 68 has embedded firmware that controls the powering and activating of the torque sensor 56, the amplifier 62, and the RF transmitter 66. The control module 68 generates power control signals, which are passed to the power module 70 for the desired timing and control. In response to the power control signals, the power module 70 supplies power to the appropriate activation pins or terminals on the transmitter controller 64.

The transmitter controller 64 may be microprocessor based such as a computer having a central processing unit, memory (RAM and/or ROM), and associated input and output buses. The transmitter controller 64 may be application-specific integrated circuits or may be in the form of other logic devices known in the art. As shown, the transmitter controller 64 has an onboard memory 72 and a transmitter communication port 74. The transmitter communication port 74 may be of various types and styles. One example of a transmitter communication port is a universal asynchronous receiver/transmitter (UART) port.

The power supply 60 includes a power source 76 and may include a voltage regulator 78. The power source 76 may be in the form of a battery or other portable, lightweight, and compact power source known in the art. In one embodiment, the power source 76 is in the form of a dual-cell battery. The regulator 78 regulates the DC voltage supplied to the transmitter circuit 58 at a desired level for proper operation.

The transmitter 66 may be of a variety of types and styles and communicate at a variety of frequencies. In one embodiment, the transmitter 66 communicates at approximately 916 MHz. Signals generated from the transmitter 66 are emitted from a transmission antenna 80.

The receiver unit 54 includes a receiver 90, which may also be RF-based, and a receiver controller 92. The receiver 90 receives the signals transmitted by the transmitter 66 via the reception antenna 94. A received signal strength indication (RSSI) device 96 may be incorporated between the receiver 90 and the receiver controller 92 to assure appropriate signal strength of the received signals. This is a squelch feature that is used to improve digital filtering. In detecting the signal strength, the number of transmission errors received as a result of the reception of white noise is minimized. White noise may be received when the transmitter 66 is not powered. The receiver controller 92 performs subsequent tasks in response to a signal strength indication by the RSSI device 96.

The receiver controller 92 may also be microprocessor based such as a computer having a central processing unit, memory (RAM and/or ROM), and associated input and output buses. The receiver controller 92 may be application-specific integrated circuits or may be in the form of other logic devices known in the art. The receiver controller 92 may be a vehicle onboard controller, a test stand controller, a stand-alone controller, or some other controller known in the art. The receiver controller 92 includes a receiver control module 98, which also has embedded firmware for controlling the reception, conversion, storage, and emission of the received signals and signals generated in response thereto.

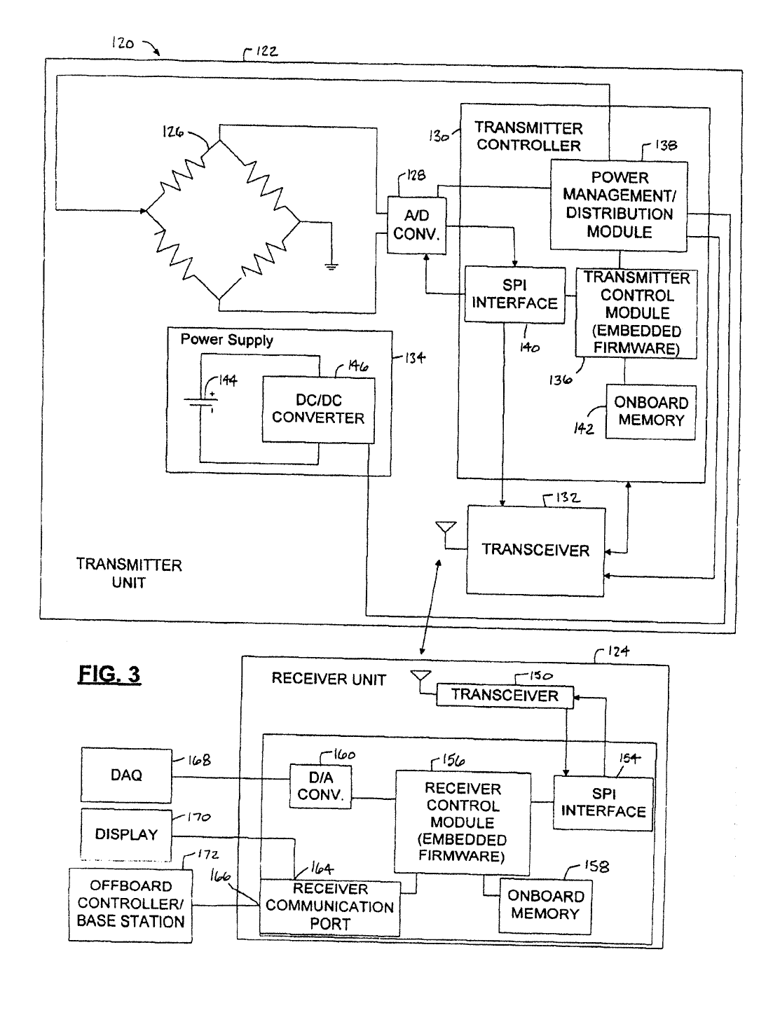

The receiver controller 98 may receive digital signals which then may be stored in the onboard memory 100, signal processed, provided to some other onboard controller (not shown), provided to an offboard controller 102, and/or converted to analog signals for reception by a DAQ 104. When converted, the digital received signals are passed through a D/A converter 105 which may be performed via a pulse-width modulated (PWM) output from the receiver controller or through an external D/A component. The receiver controller 98 may be used to monitor, analyze, and evaluate the received signals. The receiver controller 98 is in communication with the offboard controller 102 via a receiver communication port 107. The offboard controller 102 may be in the form of a test or diagnostic computer and be used to display the data received. The receiver controller 92 also receives the error correction codes from the transmitter controller 64. The receiver controller 92 uses the data received along with the error correction codes to verify the integrity of the data prior to providing the data for display or to a DAQ. When a transmission error is detected the receiver controller 92 may display the error on a display unit (not shown with respect to the embodiment of FIG. 2, however, a display is shown with respect to the embodiment of FIG. 3).

The receiver controller 92 has output ports 106, 108. The first output port 106 is coupled to the DAQ 104 and the second output port 108 is coupled to the offboard controller 102. The offboard controller 102 may have a display and be in the form of a computer. The output ports 106, 108 may be 0-5v outputs with programmable gain. In one embodiment, the second output port 108 is in the form of a UART port with an RS-232 protocol and serial port connector.

FIG. 3 provides a third exemplary torque telemetry system 120. The torque telemetry system 120 also includes a transmitter unit 122 and a receiver unit 124, which are similar to the transmitter unit 52 and the receiver unit 54. The transmitter unit 122 includes the torque sensor 126, a transmitter circuit 127, and a power supply 134. The transmitter circuit 127 has an A/D converter 128, a transmitter controller 130, and a RF transceiver 132.

A high resolution A/D converter 128 is utilized to convert the sensor or sensor/amplifier analog output to a digital output. The A/D converter 128 is interfaced with the transmitter control module 136 of the transmitter controller 130 using communication protocols and has a higher bit level than the on-board A/D converter 67. In one embodiment, the A/D converter 128 is a 16-bit converter. The use of a higher bit converter increases system resolution and can eliminate the need for a sensor amplifier. The use of the A/D converter 128 also provides greater measurement sensitivity and increased voltage measurement range. Of course, the A/D converter 128 may have a variety of bit processing or communication levels, depending upon the transmitter controller incorporated and the application.

The transmitter controller 130 is similar to the transmitter controller 64. The transmitter controller 130 includes the transmitter control module 136, the power module 138, and the onboard memory 142. Unlike the transmitter controller 64, the transmitter controller 130 is in communication with the receiver unit 124 via a transceiver 132, which may be RF-based. Also, the transmitter controller 130 communicates with the A/D converter 128 and the transceiver 132 via a serial peripheral interface (SPI) interface 140.

The power supply 134 includes a power source 144 and a DC/DC converter 146 instead of a voltage regulator. The DC/DC converter 146 converts the DC power from the power source 144 to a regulated DC voltage that is desired for the transmitter circuit 127. The use of a DC/DC converter 146 is more efficient than the use of a voltage regulator. The DC/DC converter 146 increases utilization of power source energy and allows for a reduction in the number of battery cells used. In one embodiment, the power source 144 is in the form of a single cell battery.

The receiver unit 124 includes a receiver transceiver 150, which may also be RF-based, and a receiver controller 152. The receiver transceiver 150 is in communication with the receiver controller 152 via a receiver SPI interface 154 on the receiver controller 152. Signal strength information, such as that provided by the above-described RSSI device 96, may be provided to the receiver controller 152 via the transceiver 150 using communication protocols. The receiver transceiver 150 is also used to command the manner in which error correction codes and transmission errors are received and processed by the receiver controller 152. In addition, the receiver transceiver 150 allows for the wireless upgrading of the firmware on the transmitter control module 136.

The receiver controller 152 is similar to the receiver controller 92. The receiver controller 92 includes the receiver control module 156 and the SPI interface 154, as well as an onboard memory 158, a D/A converter 160, and multiple output ports 162, 164, and 166, which are all coupled to the receiver control module 156. The D/A converter 160 is coupled to the DAQ output port 162, which in turn is coupled to a DAQ 168. The other output ports 164, 166 are shown as USB/RS-232 output ports, which are coupled to a display 170 and to an offboard controller 172, as mentioned above.

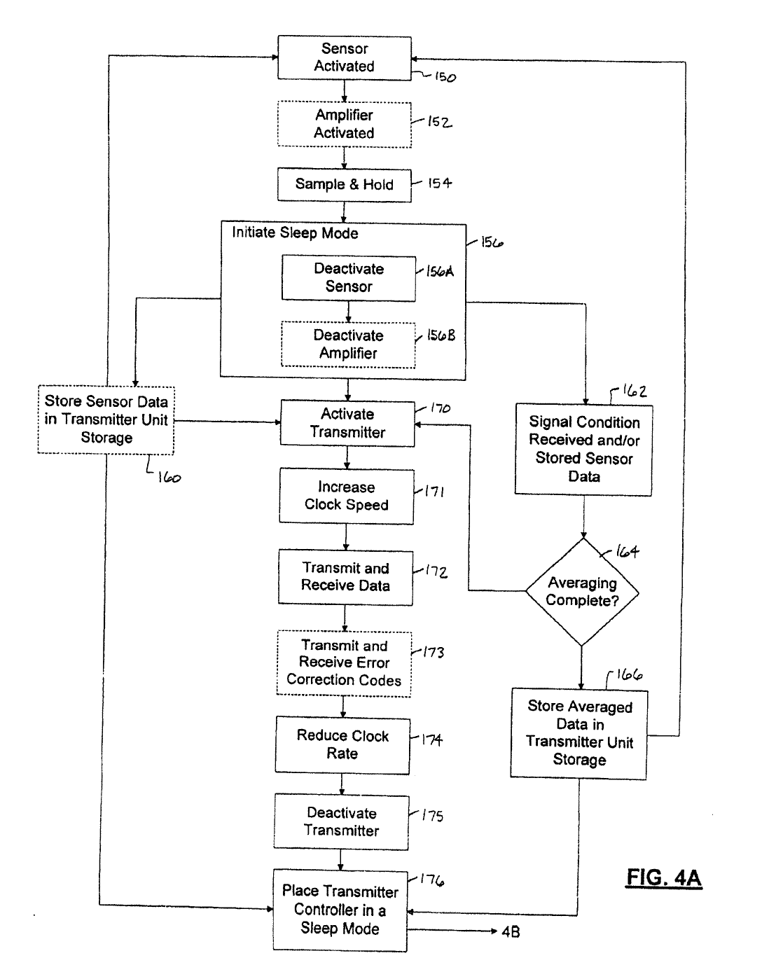

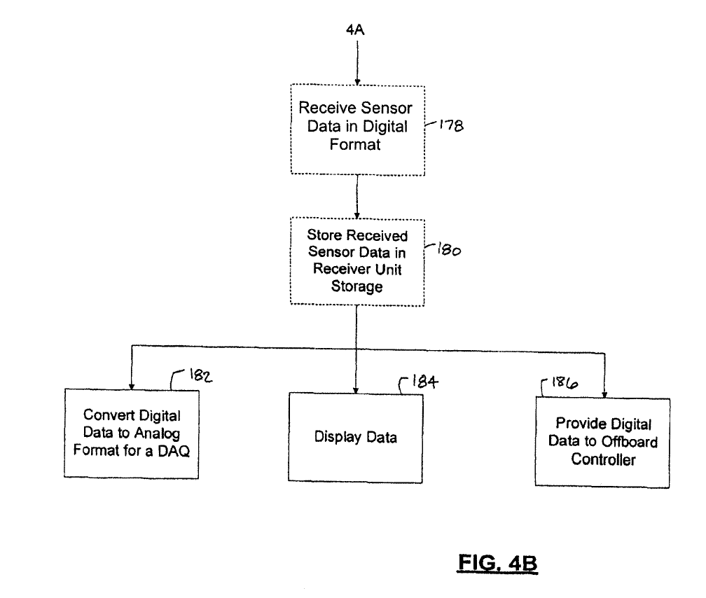

FIGS. 4A and 4B provide a logic flow diagram illustrating a method of controlling the operation of a wireless sensing system, such as one of the exemplary torque telemetry systems, including the operation of a transmitter unit thereof. In the following steps 150-176, the tasks performed by the transmitter unit, may be performed as a result of control signals received from a receiver unit, such as one of the receiver units 54 and 124, a vehicle controller, and/or from an offboard controller or base station. A base station may refer to a DAQ in a testing lab or some other offboard monitoring, controlling, analyzing, or evaluating system. The control signals may be transmitted to the transmitter unit and include activation and deactivation commands, timing information, activation durations, number of sampling bits, transmission frequencies, and other control signals or related information known in the art.

In step 150, a sensor, such as one of the torque sensors 56 and 126, is activated via the transmitter unit. A transmitter control module, such as one of the transmitter control modules 98 and 156, generates a power control signal to provide power to the sensor that is sent to a power management/distribution module, such as one of the power modules 70 and 138. The power management/distribution module may be an output pin on the transmitter control module, or may be an external device capable of delivering the required electrical power to the sensor. When activated the sensor provides a sensor output signal, such as a torque signal. The sensor is only activated for a sufficient period of time for measurement of the output signal and is deactivated when a measurement is not in progress. The transmitter controller is operated at a minimal internal clock rate to conserve energy. In step 152, when an amplifier is used, the transmitter control module of the transmitter controller activates the amplifier, such as the amplifier 62. The amplifier is deactivated when not in use. For example, the sensor and amplifier may only be activated for about 1-4 microseconds. However, the amount of time the sensor and amplifier are activated depends on the settling time required for the output signal from the sensor or sensor/amplifier and the time required to sample and hold the sensed voltage with an A/D converter. The longer it takes for the sensor or sensor/amplifier to settle into a steady signal, the longer it must be powered. The sensor or amplifier output signal may be sampled via an onboard transmitter controller A/D converter, such as the converter 66, or via a separate designated converter, such as the A/D converter 128. In step 154, the A/D converter of the transmitter control module samples and holds the sensor or sensor/amplifier output signal after which the power to the sensor and amplifier are deactivated. A continuously activated sensor, such as a 350 ohm strain gauge operating at 3 volts, and a continuously activated amplifier may require 10-15 milliamps of current from the power supply, for example. With activation and deactivation of these devices only when measurements are acquired, the average current requirement may be reduced to 0.1-2.0 milliamps.

In step 156, the transmitter control module may initiate a sleep mode while the sampled and held analog sensor signal is being converted to a digital value. In the sleep mode, the devices of the transmitter unit, in general, are deactivated until reactivated by the transmitter control module or by an off-board controller at the completion of the A/D. The transmitter control module, and thus the controller or processor thereof, is maintained in an active state. In step 156A, the transmitter control module deactivates the sensor. The power module ceases to supply power to the sensor. In step 156B, upon completion of step 154 and/or step 156 the amplifier is disabled. The power module also ceases to supply power to the amplifier. Steps 156A and 156B may be performed simultaneously or in reverse order.

Upon completion of step 156, the transmitter control module may return to step 150 or proceed to one or more of steps 160-164 and 170, depending upon the mode of operation. This determination may be made by the transmitter controller or in response to a signal received by the receiver unit, a vehicle controller, or the base station.

In step 160, the transmitter control module stores the collected data in an onboard storage for future use. Upon completion of step 160 the transmitter controller may return to step 150 or proceed to step 170 or step 176.

In step 162, the transmitter control module signal conditions or processes the collected data and/or previously recorded samples. The processing may include the averaging of the data. In one embodiment of the present invention, sixty-four (64) 10-bit samples are summed to generate a two-byte result prior to transmission to the receiver unit. Error correction codes may also be generated and stored. Although recited with respect to step 164, error correction codes may be generated during other steps of the herein described control method. In step 164, when the averaging is complete the transmitter control module proceeds to step 166 or to step 170. In step 166, the averaged data may be stored in the transmitter onboard storage. Upon completion of step 166, the transmitter controller may return to step 150 or proceed to step 170 or step 176.

In step 170, the transmitter control module activates a transmitter or transceiver, such as the transmitter or the transceiver. The transmitter or the transceiver is activated for transmission and reception thereby. The transmitter or the transceiver is deactivated when not in use. A continuously operational transmitter or transceiver may require in the range of 10-60 milliamps of average current from the power supply. An intermittently operated transmitter or transceiver, however, may require in the range of 0.1-2.0 milliamps of average current from the power supply, for example. In step 171, the transmitter control module switches from operating at a minimal clocking rate to a calibrated clocking rate for data transmission at a calibrated baud rate. In step 172, the transmitter control module transmits the collected data and/or the averaged data to a receiver unit, such as the receiver unit. The receiver unit may be in communication with the transmitter unit using communication protocols to confirm and control transmission, to confirm reception, to indicate completion of transmission, and to perform other transmission and reception tasks known in the art. The receiver unit may verify the received signal strength prior to approving or indicating proper reception to the transmitter unit. In step 173, the transmitter control module may also transmit error correction codes or the like along with the associated sensor data.

In step 174, the transmitter controller switches from operating at the calibrated clock rate required for data transmission to a minimal clock rate sufficient for completing all tasks that must be performed prior to the next data transmission. The use of a minimal clock rate within the transmitter controller for tasks other than data transmission to the receiver unit or elsewhere reduces the electrical current required to operate the transmitter controller. For instance, a transmitter controller operating at 8 Mhz may draw an average of 3 milliamps of electrical current from the power supply, while the same transmitter controller operating at 500 Khz may only draw an average of 0.6 milliamps of electrical current from the power supply. If a data packet takes 1 millisecond to transmit at the calibrated clock rate, and is transmitted every 10 milliseconds (or 100 times per second), then a controller operating at a minimum clock rate of 500 Khz can perform 4500 clock cycles to complete all required functions before the next data packet needs to be transmitted. If additional clock cycles are required to complete all tasks, the minimum clock rate must be increased. In step 175, upon completion of transmission, the transmitter control module deactivates the transmitter or transceiver and returns to step 150 or proceeds to step 176. For example, the transmitter or transceiver may only be activated for about 200-2000 microseconds. However, just as with the sensor and amplifier, this time will vary according to the specific transmitter or transceiver settling time, the transmission baud rate, and the number of bytes being transmitted during each data packet. For example, if a data packet to be transmitted consists of 5 bytes and data is transmitted with even parity checking, 1 stop bit, and at 38400 baud, the calibrated clock rate could be 845 kHz in order to achieve the desired transmission baud rate. The minimum clock rate could be between, for example, 200-500 kHz. The ideal minimum clock rate would allow the transmitter controller to receive and convert output from the sensor quickly enough to transmit data packets at the desired data acquisition rate, while at the same time not producing excessive idle clock cycles. In step 176, the transmitter controller may self-initiate a sleep mode such that the associated transmitter control unit is deactivated, depowered, or placed in a semi-activated state. A semi-activated state refers to when minimum power is utilized to maintain a reactivation clock or to perform basic tasks, such as activating the transmitter unit and/or receiving and responding to an activation signal. A reactivation clock may be calibrated to produce the desired data acquisition rate. The transmitter control module, and thus the controller or processor thereof, may be maintained in an active state or supplied power while in the sleep mode. As an alternative the transmitter control module and transmitter controller may be deactivated and may be self activated at certain time intervals, at predetermined times, or via reception of the activation signal, such as from the receiver unit, a vehicle controller, an offboard controller, a test station controller, the base station, or some other activation device, such as an inertial switch 25. Upon activation the transmitter controller returns to step 150.

In step 178, the receiver controller of the receiver unit receives the digital sensor data. In step 180, the receiver controller may store the received sensor data in an onboard memory, such as the memory unit, of the receiver unit.

In step 182, the receiver controller may convert the received or stored digital sensor data to analog format for reception by a DAQ, such as the DAQ. In step 184, the receiver controller indicated the received or stored sensor data on a display. In step 186, the receiver controller provides the received or stored sensor data to an offboard controller.

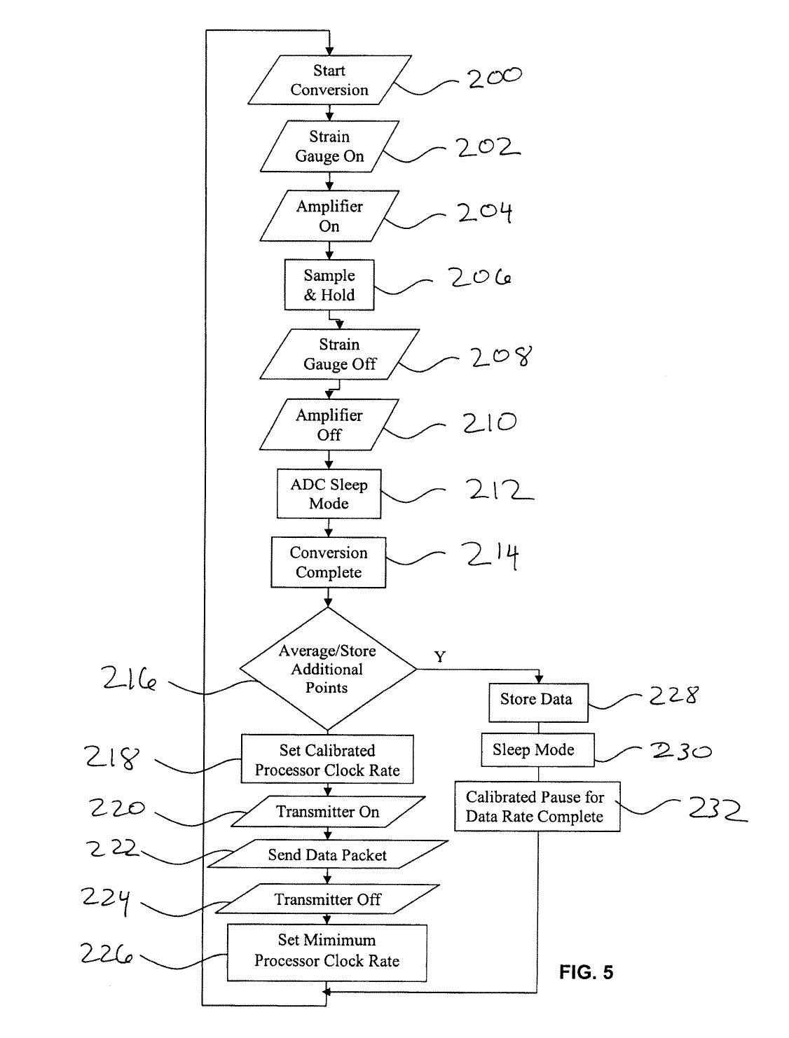

FIG. 5 provides another logic-flow diagram of an exemplary method of operating a torque telemetry system. In step 200, the transmitter control module is activated to start conversion of sensor information into digital data points. According to the exemplary method, the transmitter control module is a microprocessor. This activation could be provided, for example, by an inertial switch. The sensor according to the exemplary method is a strain gauge that is powered by the power management/distribution module. In step 202, the strain gauge is activated and produces an output voltage that is related to the amount of torque being exerted by a rotating shaft. At step 204, an amplifier is activated to boost the signal provided by the strain gauge. At step 206, the transmitter control module samples and holds the strain gauge output. At steps 208 and 210, the strain gauge and amplifier are de-activated. At step 212, the transmitter control module enters an ADC sleep mode, where the only task being performed by the microprocessor is to convert the sampled analog strain gauge signal into digital data. At step 214, the conversion is complete, which is the indication to the transmitter control module that it must re-activate. At step 216, the transmitter control module decides whether additional data points are needed, or whether it is time to transmit the current data points. If no additional points are needed, the method advances to step 218, where the calibrated processor clock rate is set by the transmitter control module. At steps 220-222, the transmitter is activated and the data packets are sent to a receiver. At step 224, the transmitter is de-activated, and at step 226 the transmitter control module returns to the minimum processor clock rate.

If, however, additional data points are desired, the method advances from step 216 to step 228 where the existing data points are stored. At step 230, the transmitter control module enters another sleep mode to await re-activation at a pre-determined time. This amount of time is referred to as a calibrated pause, and can be used to determine how much time should elapse between taking additional data points. For example, data points may only be desired every 5 seconds. At step 232, once the calibrated pause has elapsed, the transmitter control module will return to step 200 to begin taking additional data points.

During a majority of the above-described process the components of the transmitter unit, except for the transmitter controller, are deactivated. The above-described steps are meant to be illustrative examples only; the steps may be performed sequentially, synchronously, simultaneously, or in a different order depending upon the application.

The present invention increases the life span of a transmitter unit power source through minimal activation of transmitter unit components and through clock rate and thus transmitter unit speed adjustments. This reduces the size of the power source needed for transmitter unit operation and the frequency that the power source is replaced over the life of the transmitter unit. The reduction in power source size can reduce the overall size and weight of the transmitter unit. The reduction in size enables unique placement of the transmitter module. For example, the transmitter module may be mounted on the end of driveshaft beneath the universal joint and then connected to the sensor on the perimeter of the shaft via a cable. Such placement eliminates the need for counter balancing as the transmitter module is centered about the axis of the shaft. The reduction in replacement frequency of the power source directly corresponds to a reduction in the time and labor associated therewith. As a result, there is a cost savings in the purchase of each power source and in the overall costs associated with power source replacement. In the present system, the transmitter unit has demonstrated over 120 hours of continuous operation using two 3V 100 mah coin cell batteries. Using an 800 mah 9V battery, the transmitter unit has demonstrated over 1000 hours of continuous operation. An inertial switch 25 is used as a deactivation device to disable the voltage regulator 78 or DC/DC converter 146 within the power supply unit when mechanical motion is not sensed, further extending battery life during idle operation to the battery shelf life which may exceed 4 years.

Obviously, many modifications and variations of the present invention are possible in light of the above teachings and may be practiced otherwise than as specifically described while within the scope of the appended claims.

What is claimed is:

1. A method of operating a wireless sensing system comprising the steps of;
activating a sensor to generate an output,
activating a transmitter in communication with the sensor to receive the output,
transmitting the output to a receiver, and
de-activating the transmitter after said transmitting step.

2. A method as set forth in claim 1 further defined as de-activating the sensor prior to said transmitting step.

3. A method as set forth in claim 1 further defined as sampling the output prior to said transmitting step.

4. A method as set forth in claim 3 further defined as holding the output after said sampling step and prior to said transmitting step.

5. A method as set forth in claim 3 wherein said sampling step is further defined as converting the output into digital data.

6. A method as set forth in claim 5 further defined as storing the digital data in a transmitter unit storage prior to said transmitting step.

7. A method as set forth in claim 6 further defined as conditioning the digital data prior to said storing step.

8. A method as set forth in claim 7 wherein said conditioning step is further defined as averaging the digital data.

9. A method as set forth in claim 8 wherein said conditioning step is further defined as averaging sixty-four samples of the digital data.

10. A method as set forth in claim 8 further defined as re-activating the sensor after said storing step.

11. A method as set forth in claim 5 wherein said transmitting step is further defined as transmitting the digital data.

12. A method as set forth in claim 1 further defined as operating a transmitter processor at a minimal clocking rate prior to said transmitting step.

13. A method as set forth in claim 12 further defined as increasing the transmitter processor to a calibrated clocking rate prior to said transmitting step.

14. A method as set forth in claim 13 further defined as decreasing the transmitter processor to the minimal clocking rate after said transmitting step.

15. A method as set forth in claim 13 further defined as initiating a sleep-state.

16. A method as set forth in claim 1 further defined as activating an amplifier after said step of activating the sensor.

17. A method as set forth in claim 16 further defined as de-activating the amplifier prior to said transmitting step.

18. A method as set forth in claim 1 wherein said step of activating the sensor is further defined as receiving a signal from an inertial switch to indicate movement of a drive-shaft and activating the sensor in response to the signal from the inertial switch to generate the output.

19. A method of operating a wireless sensing system comprising the steps of,
supplying power from a microprocessor to a sensor,
operating the sensor to produce an output,
supplying power from the microprocessor to a transmitter in communication with the sensor for receiving the output,
operating the transmitter to transmit the output to a receiver,
said step of supplying power from the microprocessor to the sensor further defined as powering up the sensor to initiate operation and powering down the sensor to end operation, and
said step of supplying power from the microprocessor to the transmitter further defined as powering up the transmitter to initiate operation thereof and powering down the transmitter to end operation thereof.

20. A method as set forth in claim 19 further defined as powering up an amplifier after said step of activating the sensor.

21. A method as set forth in claim 20 further defined as powering down the amplifier prior to said transmitting step.

22. A method as set forth in claim 19 wherein said step of supplying power from the microprocessor to the sensor is further defined as receiving a signal from an inertial switch to indicate movement of a drive-shaft and powering up the sensor in response to the signal from the inertial switch to generate the output.

23. A method of operating a wireless sensing system comprising the steps of;
providing an inertial switch in communication with a torque sensor,
receiving a signal from the inertial switch to indicate movement of a drive-shaft,
activating the torque sensor to generate an output based upon torque exerted on the drive-shaft,
receiving a signal from the inertial switch to indicate inactivity of the drive-shaft,
de-activating the torque sensor, and
converting the output into digital data.

24. A method as set forth in claim 23 further defined as activating a transmitter after said converting step.

25. A method as set forth in claim 24 further defined as transmitting the digital data to a receiver.

26. A method as set forth in claim 25 further defined as de-activating the transmitter.
